(19) United States
(12) Patent Application Publication
(10) Pub. No.: US 2016/0022388 A1
(43) Pub. Date: Jan. 28, 2016

(54) Surgical Instruments

(71) Applicant: NEOSS LIMITED, Yorkshire (GB)

(72) Inventors: Christer Fässberg, Stenkullen (SE); Fredrik Engman, Molnlycke (SE)

(21) Appl. No.: 14/811,344

(22) Filed: Jul. 28, 2015

(30) Foreign Application Priority Data
Jul. 28, 2014 (GB) 1413344.1

(51) Int. Cl. A61C 8/00; A61C 1/14; A61C 19/02; A61C 1/08

(52) U.S. Cl. CPC A61C 8/0089; A61C 1/084; A61C 1/14; A61C 19/02

(57) ABSTRACT

A set of surgical instruments for use in a surgical procedure to insert an implant, particularly a dental implant, in the bone of a patient comprises at least one drill hub configured for connection between a surgical drill handpiece and a drill. The drill is driveable by the drill handpiece via the drill hub. The drill hub has an end surface having defined therein a socket configured for receiving the drill. The socket has a defined depth to provide a predetermined extent of the drill from the end surface.

### BACKGROUND

In surgical procedures to insert implants, such as dental implants, in the bone of a patient, it is important that the implant is precisely located. This requirement has led to the provision of complicated systems of surgical instruments for the implant procedures, specifically in relation to surgical planning systems or placement of implants through surgical guides which require the need for dedicated surgical dental drills with built in stops to contact a guide member or guide key to achieve a certain anatomical position. Hence, typically near complete duplications of drill assortments are common to provide a solution for guided surgery for an implant system.

The present invention, at least in its preferred embodiments, seeks to provide a simplified system for implant procedures, which while easy to use maintains high levels of accuracy and minimizes the inventory of instruments required.

### BRIEF SUMMARY OF THE DISCLOSURE

In accordance with the present invention there is provided a set of surgical instruments for use in a surgical procedure to insert an implant, particularly a dental implant, in the bone of a patient. The set comprises at least one drill hub configured for connection between a surgical drill handpiece and a drill. The drill is driveable by the drill handpiece via the drill hub. The drill hub has an end surface having defined therein a socket configured for receiving the drill. The socket has a defined depth to provide a predetermined extent of the drill from the end surface.

Thus, according to the invention, the drill hub is configured to provide a predetermined extent or length of the drill relative to the end surface. In this way, the end surface of the drill hub can be used to engage a stop surface, for example on an implant guide in order to limit the axial movement of the drill and therefore the depth of an osteotomy. This solution enables the use of conventional and existing dental drills, which do not have any special adaptation in order to be used in conjunction with a guide.

The set may comprise a plurality of said drill hubs. The defined depth of the socket of each drill hub may be different. In this way a drill hub can be selected from the set to provide a required extent of the drill from the end surface, for example to achieve a depth of the osteotomy to match a selected length of implant.

The stop surface engaged by the end surface of the drill hub is provided on an implant guide or on a guide sleeve provided on an implant guide. The set comprises at least one guide member having a stop surface for engaging the end surface of the drill hub. The guide member has defined in (or adjacent to) the stop surface a guide passage for receiving the drill. Engagement of the stop surface with the end surface of the drill hub limits further axial movement of the drill relative to the stop surface. The guide passage may have a defined diameter which fits a predetermined drill. This has the advantage of providing axial and/or lateral guidance for the drill to improve accuracy in the creation of the osteotomy.

The set may comprise a plurality of guide members. The defined diameter of the guide passage of each guide member may be different. In this way a guide member can be selected from the set to fit a required drill. The external diameter of each guide member may be the same in order that each guide member fits with a guide sleeve of an implant guide. The guide member may be configured to be received within a guide sleeve of an implant guide. Engagement of the guide member with the guide sleeve may align the axis of the guide passage with the axis of the guide sleeve. The guide member may comprise an engagement surface arranged to engage with an end surface of the guide sleeve whereby to limit axial movement of the guide member relative to the guide sleeve. The engagement surface may be in the form of a flange or shoulder, for example.

In an embodiment, the guide member and/or the guide sleeve and/or the implant guide may each include a substantially vertical slot therein via which a drill can be inserted laterally into said guide passage. The guide sleeve and the implant guide, at least, could have a substantially C-shaped cross-sectional shape when viewed from above. Optionally the guide member may also have such a slot therein. It is advantageous to be able to insert the drill laterally into the guide passage in situations where the interocclusal height is limited. The guide sleeve may optionally be made from a low friction material such as a treated metal surface or a polymer like PEEK.

Implant guides can be designed and produced with guide sleeves at different positions or heights in relation to the implant. One drill hub can then be used to achieve different drill depths to host different implant lengths. A set of drill hubs of different socket depths can be used in combination with different guide sleeve positions or heights to improve accessibility in compromised cases such as low vertical height or deep implant placement with close adjacent teeth. The socket depth of the drill hub and the different positions or heights of the guide sleeve are correlated to achieve a required drill depth. These correlations may be represented to the user in a simple look-up table.

The drill may be a standard drill or a countersinking drill, for example. Typically, several different drills will be used during the same procedure. The guide member may mount on a shaft of the drill, for example in cases with limited access, or in the case of a countersinking drill, where this allows the guide passage of the guide member to be narrower than the width of the cutting surfaces of the countersinking drill.

The set may further comprise an implant mount configured for connection between a surgical drill handpiece and an implant. The implant is driveable by the drill handpiece via the implant mount. The implant mount may have a body portion having a first diameter and a stop portion which extends radially beyond the body portion. The body portion may be receivable within a guide sleeve of an implant guide with the stop portion engaging the guide sleeve to limit axial movement of the implant mount relative to the guide sleeve. Typically, the implant mount is provided with a suitable fitting for connection to the implant. The implant mount may be provided with a screw for retaining the implant on the implant mount. The stop portion may be in the form of a circumferential flange or shoulder.

The set may comprise a guide implant insert. The guide implant inserter may comprise a shaft for connection to a drill handpiece and a fitting at an opposite end thereof for connection to an implant. Between the shaft and the fitting, the guide implant inserter may comprise a body portion. The body portion may be substantially cylindrical. The body portion may have a diameter which corresponds to the internal diameter of a guide sleeve, whereby the guide implant inserter is laterally guided on insertion into a guide sleeve. The guide implant inserter may be provided with depth markings on the body portion. The relative position of the depth markings to an end surface of a guide sleeve can be used by a surgeon to determine the inserted depth of an implant.

The guide implant inserter may be used to drive the implant mount. In this case, the implant mount may be provided with a suitable female fitting to receive the fitting of the guide implant inserter, this internal female fitting being similar to an implant connection.

The implant may be inserted using the implant mount or the guide implant inserter without the implant mount. With the implant mount, the insertion of the implant can be considered to be fully guided, because the stop portion of the implant mount determines the insertion depth of the implant. Without the implant mount, the insertion of the implant can be considered to be partially guided, because the insertion depth of the implant is determined by the surgeon by reference to the depth markings on the guide implant inserter and not a discrete stop.

The invention extends to a drill hub configured for use in the set, to a guide member configured for use in the set and to an implant mount and/or a guide implant inserter configured for use in the set. The invention also extends to an implant guide provided with at least one guide sleeve dimensioned for use with the set of instruments. Guide sleeves dimensioned for use with the set may be provided to implant guide manufacturers.

The invention further extends to a surgical procedure to insert an implant using the set of instruments.

### BRIEF DESCRIPTION OF THE DRAWINGS

Embodiments of the invention are further described hereinafter with reference to the accompanying drawings, in which:

FIG. 1A is a perspective view of a set of instruments in accordance with an embodiment of the invention;

FIG. 1B is a detailed and selectively magnified view of instruments of the set of FIG. 1A and a guide sleeve for use therewith;

FIG. 2 shows the use of a guide instrument for preparing an osteotomy for receiving a dental implant in accordance with an embodiment of the invention;

FIG. 3 is a schematic representation of the placement of a dental implant relative to an implant guide and its guide sleeves;

FIGS. 4A to 4G represent schematically various stages of the process of fixation of a dental implant in accordance with an embodiment of the invention;

FIG. 5 is a schematic and sectional view of a drill hub in accordance with an embodiment of the invention; and

FIG. 6 shows a look-up table for use with the instrument set of FIG. 1.

### DETAILED DESCRIPTION

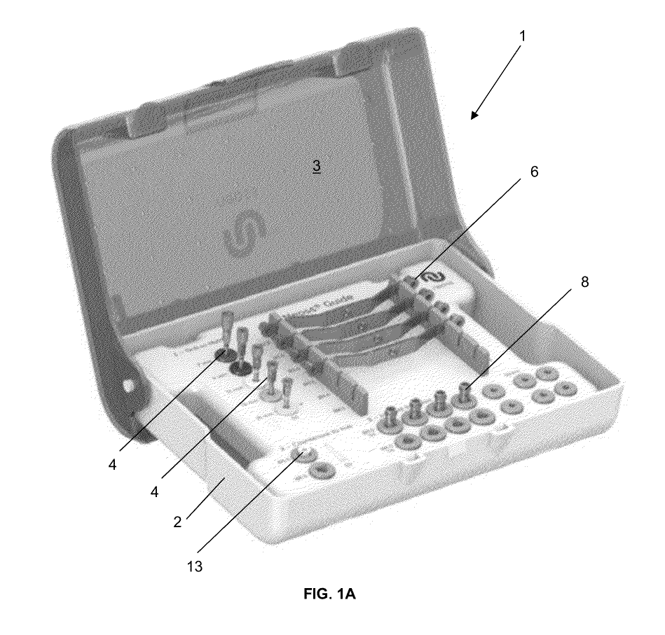

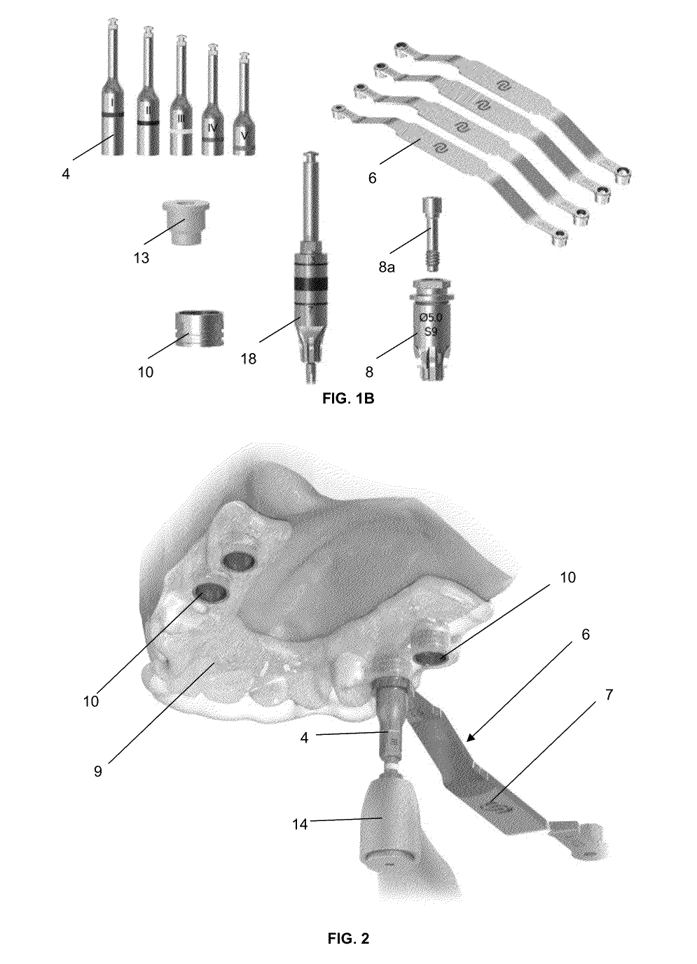

FIG. 1A shows a perspective view of a set 1 of dental instruments in accordance with an embodiment of the invention. The instruments are shown in more detail in selectively enlarged views in FIG. 1B. The set 1 is provided in a tray 2 which stores the instruments in instrument-specific locations within the tray 2 for ease of reference and safe transportation. Before use, the tray 2 is closed by a lid 3.

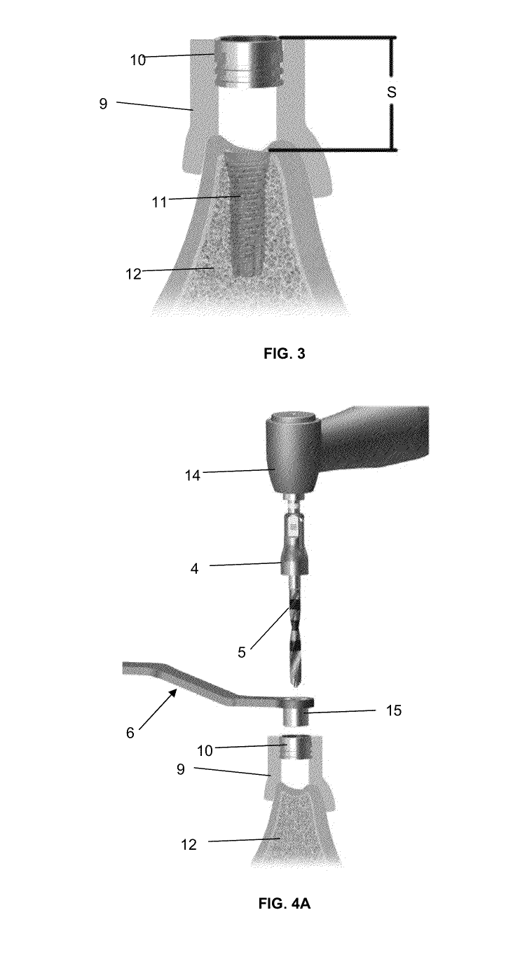

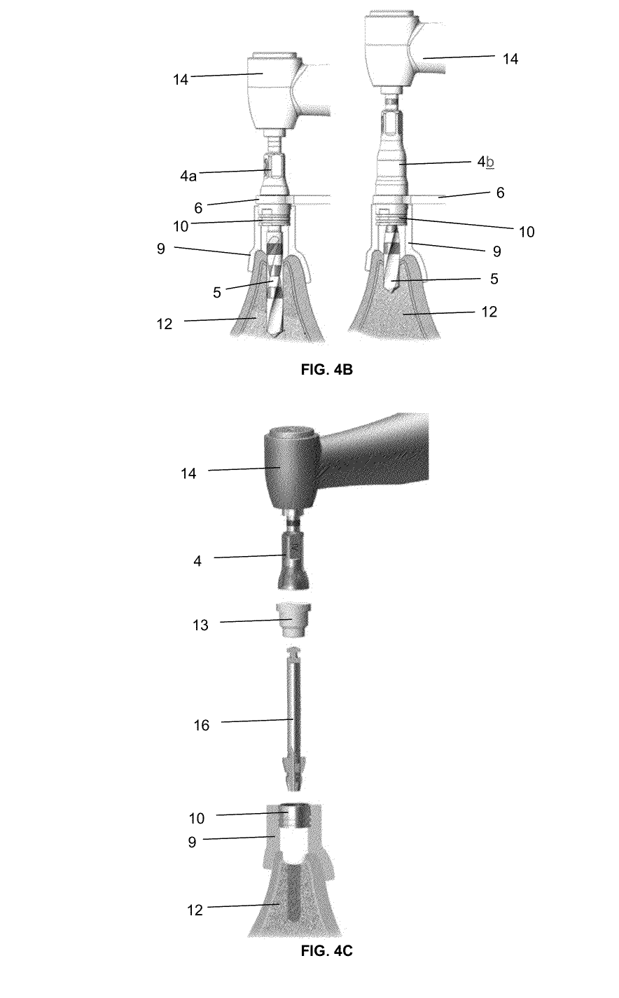

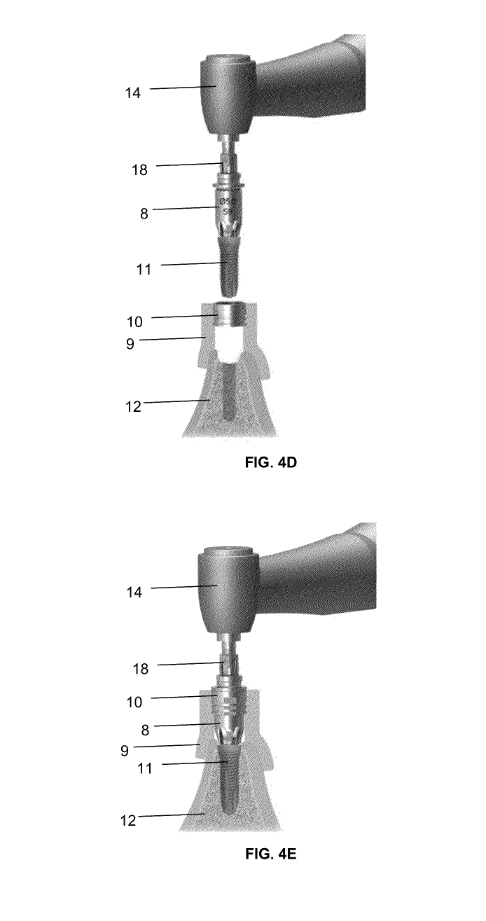

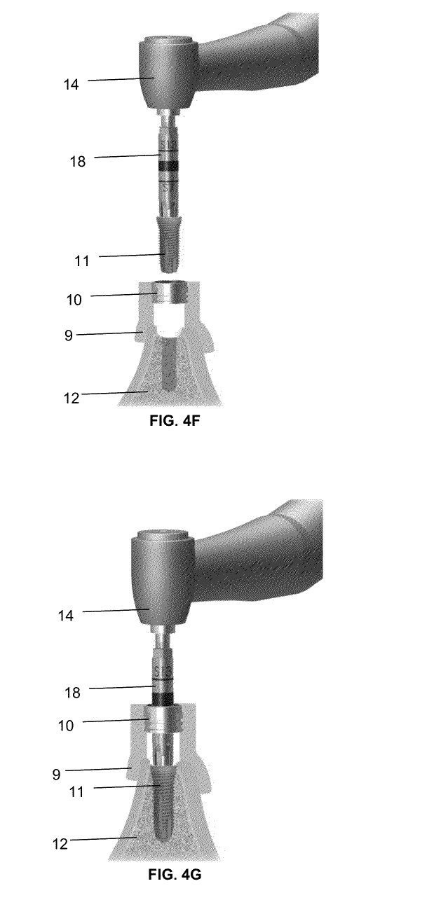

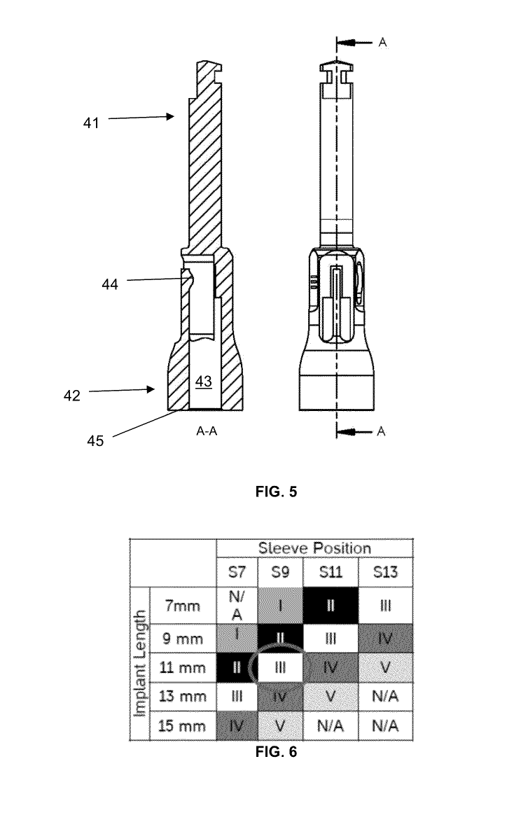

The set (or assortment) 1 of instruments comprises a plurality of drill hubs 4. In the example shown, five drill hubs 4 are provided. Each drill hub 4 has a male end 41 and a female end 42 (shown in more detail in FIG. 5). The male end 41 of the drill hub 4 is dimensioned to be received by a standard dental drill handpiece in a similar way to a standard dental drill. The female end 42 of the drill hub 4 is provided with a socket 43 that is dimensioned internally to receive a standard dental drill 5. The socket 43 is provided with a formation 44 to retain the dental drill 5 in position in the socket 43. The depths of the sockets 43 or the configuration of the drill hubs 4 in the set differ so that the exposed length of the drill 5 when inserted in a respective drill hub 4 differs. The end surface 45 of the female end 42 of the drill hub 4 acts as a drill stop in the manner explained below so that the use of a particular drill hub 4 from the set 1 determines the depth of the osteotomy provided by the drill 5. Each drill hub 4 is located in the tray 2 by inserting the male end 41 of the drill hub 4 into a colour-coded hole in the tray. Each drill hub 4 is also numbered (from I to V in the example, with drill hub III shown in FIGS. 2 and 4A). Each of the numbered drill hubs 4 is associated with a different length of the exposed drill allowing for a depth of the osteotomy and corresponding implant length of 7 mm (red), 9 mm (black), 11 mm (white), 13 mm (green) and 15 mm (yellow). Therefore the longest drill hub 4 in FIG. 1 corresponds to the 7 mm implant length and the shortest drill hub 4 corresponds to the 15 mm implant length. This is illustrated in FIG. 4B where the guide sleeve 10 is positioned at the same height in both illustrations and the same drill 5 is being used but by changing the drill hub from drill hub 4a to drill hub 4b the drill depth is decreased as indicated. The implant length is indicated adjacent the respective drill hub 4 on the tray 2. A look-up table may be provided to the user, as shown in FIG. 6, which shows the required drill hub (I-V), for use with each guide sleeve position, for example S, (see FIG. 3) and implant length.

The set 1 of instruments further comprises a plurality of guide members or guide keys 6. In the example shown, four guide keys 6 are provided. Each guide key 6 has a first end and a second end connected by a handle 7. Each end of the guide key 6 has defined therein a guide passage to receive and guide a dental drill 5. The diameter of the guide passages range from 2.2 mm to 4.1 mm, with each guide key 6 having a smaller diameter guide passage at its first end and a larger diameter guide passage at its second end. The guide passage diameters of the guide keys 6 shown in the example are 2.2/2.85 mm, 3.0/3.2 mm, 3.4/3.6 mm and 3.9/4.1 mm, which correspond to the existing and conventional dental drills for a dental implant system, providing a guide solution which utilises conventional dental drills 5. The diameters of the guide passages correspond to the increasing diameters of the drills 5 which are used to widen the osteotomy from the initial drilled hole to the required diameter for an implant. In the example shown the set 1 is intended for use with implants of diameter 3.5 mm to 4.5 mm.

The set 1 further comprises a countersink conduit 13, the function of which will be described in more detail in relation to FIG. 4B and a plurality of implant mounts 8, the function of which will be described in more detail in relation to FIG. 4C.

As shown in FIG. 2, the instruments of the set 1 are used in conjunction with a pre-formed implant guide 9. The implant guide 9 is formed in known manner to fit over the patient's remaining teeth, gum and/or bone and is provided with guide holes for the required implants according to the patient's treatment plan. As shown in FIGS. 2 and 3, in accordance with the invention, the guide holes are provided with respective guide sleeves 10. The guide sleeves 10 have an internal diameter of 5.0 mm and are provided to receive the countersink conduit 13 and the ends of the guide keys 6, as will be explained below in relation to FIGS. 4A to 4G.

FIG. 3 shows schematically a cross-section through the jaw of a patient indicating the required location of the dental implant 11 within the osteotomy in the patient's jaw bone 12. Importantly, the implant guide 9 is formed such that the spacing S between the abutment surface of the implant 11 and the end surface of the guide sleeve 10 is fixed, in this example at 9 mm, corresponding to S9 in FIG. 6. This is important because the end surface of the guide sleeve 10 provides a reference surface for engagement with the ends of the guide keys 6 and the countersinking conduit 13 to ensure that drilling and countersinking operations are performed to precisely the correct depth, as explained below. Moreover, the outer diameter of the countersinking conduit 13 and the ends of the guide keys 6 is 5.0 mm in order that the countersinking conduit 13 and the ends of the guide keys 6 mate accurately with the guide sleeve 10 when inserted therein.

In accordance with the invention, the implant procedure has three stages: drilling (FIGS. 4A and 4B); countersinking (FIG. 4C); and insertion (FIGS. 4D and 4E or FIGS. 4F and 4G).

As shown in FIG. 4A, for the drilling stage to create the osteotomy, a drill hub 4 is connected by means of its male end to a dental drill handpiece 14 and to a drill 5 of the required diameter by means of the female end of the drill hub 4. In this way, the dental drill handpiece 14 is able to drive the drill 5 via the drill hub 4. The implant guide 9 is located in position on the patient's jaw (as shown in FIGS. 2 and 3) and the guide sleeve 10 is thereby correctly located relative to the desired location of the implant 11. A guide key 6 is selected having one end 15 with a guide passage having a diameter corresponding to the diameter of the drill 5. The end 15 of the guide key 6 is inserted into the guide sleeve 10 and mates therewith. The drill 5 is inserted into the guide passage, and in this way the guide passage locates the drill 5 in the centre of the desired location of the implant 11 and ensures that that the drill travels in the direction of the axis of the guide passage, which is also the axis of the guide sleeve 10 and the implant 11. The drill 5, driven by the dental drill handpiece 14, is then guided into the jaw bone to form (or enlarge) the osteotomy, until the end surface of the drill hub 4 engages the end surface of the guide sleeve 10. The engagement of the drill hub 4 with the guide sleeve 10 stops further axial movement of the drill. As explained above, the drill hub 4 is selected from the set 1 to achieve the required depth of the osteotomy when the drill hub 4 engages the guide sleeve 10.

As shown in FIG. 4C, for the countersinking stage, a drill hub 4 (which may be different to the drill hub 4 used in the drilling stage) is connected by means of its male end to a dental drill handpiece 14 and to a proximal end of a countersinking drill 16 by means of the female end of the drill hub 4. In this way, the dental drill handpiece 14 is able to drive the countersinking drill 16 via the drill hub 4. Before the countersinking drill 16 is fitted to the drill hub 4, the countersinking conduit 13 is fitted over the proximal end of the countersinking drill 16. The internal diameter of the countersinking conduit 13 is small enough to fit closely around the shaft of the countersinking drill 16 and is therefore smaller than the diameter of the cutting surfaces at the distal end of the countersinking drill 16. However, the diameter of the cutting surfaces of the countersinking drill 16 is smaller than the internal diameter of the guide sleeve 10 in order that the distal end of the countersinking drill 16 can pass through the guide sleeve 10 to the osteotomy. The implant guide 9 is located in position on the patient's jaw (as in FIG. 4A) and the guide sleeve 10 is thereby correctly located relative to the desired location of the implant 11. Once the distal end of the countersinking drill 16 has passed through the guide sleeve 10, the countersinking conduit 13 is inserted into the guide sleeve 10. The countersinking conduit 13 is formed of a main body and an end flange. The external diameter of the main body corresponds to the internal diameter of the guide sleeve 10 so that the countersinking conduit 13 is located precisely in the guide sleeve 10. The end flange of the countersinking conduit 13 has a larger diameter than the diameter of the main body and engages the end surface of the guide sleeve 10 to restrain axial movement of the countersinking conduit 13. In this way the countersinking conduit 13 locates the countersinking drill 16 in the centre of the desired location of the implant 11 and ensures that that the countersinking drill 16 travels in the direction of the axis of the guide sleeve 10 and the implant 11. The countersinking drill 16, driven by the dental drill handpiece 14, is then guided towards the jaw bone to countersink the osteotomy. Axial movement of the countersinking drill 16 is limited by the end surface of the drill hub 4 engaging the end surface of the countersinking conduit 13. The drill hub 4 is selected from the set 1 to achieve the required depth of countersinking when the drill hub 4 engages the countersinking conduit 13. The drill hub 4 selected for the countersinking stage may be different to the drill hub 4 selected for the drilling stage in order to achieve the required depth of countersinking

As shown in FIGS. 4D and 4E in one variant of the insertion stage, an implant mount 8 is connected by means of its female end to a dental drill handpiece 14 via an guide implant inserter 18 and to the implant 11 by means of the male end of the implant mount 8, which is provided with a suitable screwdriver head that engages a complementary recess in the implant 11. The implant mount 8 is secured to the implant 11 by a screw 8a, which is received in a screw thread in the implant 11. In this way, the dental drill handpiece 14 is able to drive the implant 11 via the guide implant inserter 18 and the implant mount 8. The implant guide 9 is located in position on the patient's jaw (as in FIGS. 4A and 4B) and the guide sleeve 10 is thereby correctly located relative to the desired location of the implant 11. The external diameter of the body of the implant mount 8 corresponds to the internal diameter of the guide sleeve 10 so that the implant mount 8 is located precisely in the guide sleeve 10. The implant mount 8 is provided with a circumferential flange which has a larger diameter than the diameter of the body of the implant mount and engages the end surface of the guide sleeve 10 to restrain axial movement of the implant mount 8. In this way the implant mount 8 travels in the direction of the axis of the guide sleeve 10 and the implant 11. The implant mount 8 and implant 11, driven by the dental drill handpiece 14, are guided towards the jaw bone to drive the implant into the osteotomy. Axial movement of the implant mount 8 is limited by the circumferential flange of the implant mount 8 engaging the end surface of the guide sleeve 10. The implant mount 8 is dimensioned to achieve the required depth of the implant 11 in the osteotomy when the circumferential flange engages the guide sleeve 10.

As shown in FIGS. 4F and 4G, in an alternative to an implant mount 8, an guide implant inserter 18 may be used directly to insert the implant 11. The guide implant inserter 18 is connected by means of a shaft to a drill handpiece 14 and to the implant 11 by means of the male end of the guide implant inserter 18, which is provided with a suitable screwdriver head that engages a complementary recess in the implant 11. In this way, the handpiece 14 is able to drive the implant 11 via the guide implant inserter 18. The implant guide 9 is located in position on the patient's jaw and the guide sleeve 10 is thereby correctly located relative to the desired location of the implant 11. The external diameter of the body of the guide implant inserter 18 corresponds or fits into the internal diameter of the guide sleeve 10 so that the guide implant inserter 18 is located precisely in the guide sleeve 10. The guide implant inserter 18 is provided with depth marks corresponding to the height position of the guide sleeve and depending on implant length a chart provides the accurate marking to align to the top of the guide sleeve 10. The accuracy of placement with this method of implant insertion is generally less favourable than using the fully guided system with an implant mount but is still accurate and has more flexibility for the surgeon to cater for a wider spread of clinical applications ranging from deeply submerged implants to cases with limited occlusal height.

It will be seen from the above that the set 1 of instruments provides complete and accurate location of the implant 11 relative to the implant guide during the drilling, countersinking and insertion stages. By mating with the guide sleeve 10, the guide key 6 aligns the drill 5 along the correct axis and limits axial movement of the drill 5 to the required depth, the countersinking conduit 13 aligns the countersinking drill 16 along the correct axis and limits axial movement of the countersinking drill 16 to the required depth, and the implant mount 8 aligns the implant 11 along the correct axis and limits axial movement of the implant 11 to the required depth.

Thus, embodiments of the invention provide a fully guided solution for surgical preparation using existing drills with subsequent placement of implants of diameter for example 3.5 to 4.5 mm. The system has been designed to maximize ease of use and simplicity with the highest degree of accuracy based on existing instruments, i.e. drills, countersinks, and using existing implant planning software and implant guide construction. The result is improved dental implant placement using a most efficient and cost effective method. The system achieves: integration with existing surgical drill components; minimum complexity relative to currently available guided systems with large assortments and complex procedures; versatility to allow for use with most currently available surgical implant guides; a safe and accurate drilling protocol with “drill to hub” and “countersink to hub” providing fully guided implant placement for implants applying “implant insertion to hub”; and a versatile method that allows the sleeve position at various heights to cater for a wide spread of clinical applications ranging from deeply submerged implants to cases with limited occlusal height.

According to embodiments of the invention treatment planning is carried out using existing planning software and the implant guide can be manufactured by an existing guide provider.

Throughout the description and claims of this specification, the words “comprise” and “contain” and variations of them mean “including but not limited to”, and they are not intended to (and do not) exclude other components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

1. A set of surgical instruments for use in a surgical procedure to insert a dental implant in a bone of a patient, the set comprising at least one drill hub configured for connection between a surgical drill handpiece and a drill driveable by the drill handpiece via the drill hub, the drill hub having an end surface and having defined therein a socket configured for receiving the drill, wherein the socket has a defined depth to provide a predetermined extent of the drill from the end surface, wherein the set further comprises at least one guide member, the guide member having a stop surface for engaging the end surface of the drill hub and having defined in the stop surface a guide passage for receiving the drill, wherein engagement of the stop surface with the end surface of the drill hub limits further axial movement of the drill relative to the stop surface.

2. The set of surgical instruments of claim 1, wherein the set comprises a plurality of said drill hubs, wherein the defined depth of the socket of each drill hub is different, such that a drill hub can be selected from the set to provide a required extent of the drill from the end surface.

3. (canceled)

4. The set of surgical instruments of claim 2, wherein the guide passage has a defined diameter which fits a predetermined drill.

5. The set of surgical instruments of claim 4, wherein the set comprises a plurality of said guide members, wherein the defined diameter of the guide passage of each guide member is different, such that a guide member can be selected from the set to fit a required drill.

6. The set of surgical instruments of claim 1, wherein the guide member is configured to be received within a guide sleeve of an implant guide, whereby engagement of the guide member with the guide sleeve aligns the axis of the guide passage with the axis of the guide sleeve.

7. The set of surgical instruments of claim 6, wherein the guide member comprises an engagement surface arranged to engage with an end surface of the guide sleeve whereby to limit axial movement of the guide member relative to the guide sleeve.

8. The set of surgical instruments of claim 1, wherein the drill is a countersinking drill and the guide member mounts on a shaft of the countersinking drill.

9. The set of surgical instruments of claim 1, further comprising an implant mount configured for connection between a surgical drill handpiece and an implant, wherein the implant is driveable by the drill handpiece via the implant mount, the implant mount having a body portion having a first diameter and a stop portion which extends radially beyond the body portion, wherein the body portion is receivable within a guide sleeve of an implant guide with the stop portion engaging the guide sleeve to limit axial movement of the implant mount relative to the guide sleeve.

10. The set of surgical instruments of claim 9, wherein the stop portion is in the form of a circumferential flange or shoulder.

11. The set of surgical instruments of claim 1, further comprising a guide implant inserter configured for connection between a surgical drill handpiece and an implant, wherein the implant is driveable by the drill handpiece via the guide implant inserter, the guide implant inserter having a body portion having a first diameter, wherein the body portion is receivable within a guide sleeve of an implant guide to guide axial movement of the guide implant inserter during insertion of the implant.

12. The set of surgical instruments of claim 11, wherein the body portion is provided with depth markings which align with an end surface of a guide sleeve to indicate an insertion depth of the implant.

13-17. (canceled)

18. A surgical procedure, comprising:
using a set of instruments as claimed in claim 1 to insert a dental implant in a bone of a patient.

19. The set of surgical instruments of claim 6, wherein the guide member and/or the guide sleeve and/or the implant guide each include a substantially vertical slot therein via which a drill can be inserted laterally into said guide passage.
